(19) United States
(12) Patent Application Publication
(10) Pub. No.: US 2004/0039067 A1
(43) Pub. Date: Feb. 26, 2004

(54) Gel for moisture control and device

(76) Inventor: Marcel Theodrus Antonius Gerardus Klaassen, Wervershoof (NL)

Correspondence Address: John W McIlvaine, 700 Koppers Building, 436 Seventh Avenue, Pittsburgh, PA, 15219-1818, US

(21) Appl. No.: 10/343,398

(22) PCT Filed: Aug. 2, 2001
(86) PCT No.: PCT/NL01/00587

(30) Foreign Application Priority Data
Aug. 3, 2000 (NL) 1015869

(51) Int. Cl. C09K 3/00

(52) U.S. Cl. 516/98

(57) ABSTRACT

The invention relates to a method for controlling the moisture content of a local atmosphere, wherein at least one gel body is placed in the atmosphere for influencing, into which gel body is bonded water, wherein the moisture content is determined by means of transport of water between the gel body and the local atmosphere. The invention also relates to a gel body and device for applying such a method.

The present invention relates to a method for controlling the relative humidity of the atmosphere in a spacemoisture content of a local atmosphere, wherein at least one gel body is places in the atmosphere for influencing, into which gel body is bonded water. wherein the moisture content is determined by means of transport of water between the gel body and the local atmosphere. The invention also relates to a gel body for applying such a method, wherein the gel body comprises an air-humidifying substance into which water is bonded and to a device for controlling the moisture content of the atmosphere in an at least substantially closed space, comprising: a gel body according the present invention. a housing at least partially enclosing the space and at least one receptacle arranged in the space at least substantially closed by the housing for containing a material regulating the relative humidity.

Controlling the moisture content of the atmosphere in a space is a particular concern in storage spaces or packages for products, where the quality of the products is related to the moisture content thereof. A known example is a packaging for one or more cigars, also referred to as a humidor. Existing humidors vary considerably in design; there are thus large standing cabinets and small table models. For purposes of air humidification the existing humidors are mainly provided with a receptacle for containing a liquid (usually demineralized water mixed with a glycol). The drawbacks of these receptacles are that the liquid thus present in a humidor can result in leakages and it the liquid which is present may form a basis for (for instance bacterial) contamination. While there are also humidors in which the liquid which is present is arranged in an absorption element, for instance an oasis, this can also result in undesirable contamination, and the absorption element moreover takes up a considerable amount of space (relative to the volume of the liquid for absorbing). Another drawback of existing humidors is that they require regular servicing, such as for instance replenishing of liquid in the receptacle and cleaning of the humidor.

The U.S. Pat. No. 5,829,452 discloses a humidification device in the form of a container having a wall thickness and constitution which permits water vapor to escape therethrough, but will not permit water droplets or palpable moisture to pass therethrough and subsequently over-wet the material to be humidified, such as cigars. The patent proposes in the device the use of a material capable of absorbing and retaining water that is selected from the group consisting of acrylamide potassium acrylate copolymer, cross linked. More specific the patent mentions two of these copolymers sold under the trademark Stockord™ by Stockhausen or as a suitable substitute Aquitain 2-4 MM® sold by Aquitain, Inc. A polyacrylamide gel is an absorption gel and, as such, functions only as absorbent material for water. A first drawback of such absorption gels is that the ration of water and gel is not constant; when water evaporates the percentage of water in the gel decreases whereby the gel changes physically. The ratio of water and other components of the gel cannot therefore be held water content of an atmosphere surrounding the absorption gel. A second drawback of polyacrylamide absorption gels is that they can retain moisture-regulating components other than water only with difficulty if the water percentage in the absorption gel falls considerably. When some of the water evaporates the hygroscopic components can become fluid and thereby begin to leak. A polyacrylamide absorption gel is not suitable for long-term use in a humidor.

The international patent application WO 94 19940 describes a method of packaging entomopathegenic nematodes for storage and transportation. The nematodes are placed in a container where the atmospheric humidity lies between 85% and 99%. The moisture content in the atmosphere present in the container is regulated by porous packaging in which gel bodies preferably manufactured from polyacrylamide are positioned. A polyacrylamide gel is an absorption gel and, as such, function only as absorbent material for water. A first drawback of such absorption gels is that the ratio of water and gel is not constant; when water evaporates the percentage of water in the gel decrease whereby the gel changes physically. The ratio of water and other components of the gel is not constant. The water content of an atmosphere surrounding the absorption gel cannot therefore be held constant, or hardly so, using only a prior art absorption gel. A second drawback of polyacrylamide absorption gels is that they can retain moisture regulating components other than water only with difficulty if the water percentage in the absorption gel falls considerably. When some of the water evaporates the hygroscopic components can become fluid and thereby begin to leak. A polyacrylamide absorption gel is not suitable for long-term use in a humidor.

The present invention has for its object, while preserving the advantages of the prior art, of providing a simple solution for determining the moisture content of a local atmosphere in a more controlled manner, also for application options not existing heretofore.

The invention provides for this purpose a method for controlling the moisture content of a local atmosphere wherein at least one gel body is placed in the atmosphere for influencing, into which gel body is bonded water, wherein the moisture content is determined by means of transport of water between the gel body and the local atmosphere according claim 1. Preferably the chemical composition of the gel body is varied by applying varying ratio's of (mono)propylene glycol, glycerine and water. By varying the chemical composition of the gel body it is possible to choose the level of humidity of a local atmosphere to be maintained dependant on the requirements of the application. Another important advantage of this method is that the ratio of water and other components of the gel can be kept constant; so also the water content of a local atmosphere surrounding the absorption gel can kept constant. A gel body of this type has the very significant advantage that of liquid is impossible as no free liquid is present. A gel body is built up of a gelatinous substance which is for instance formed by flocculation or coagulation of at least one colloidal liquid. The gelatinous substance generally has the property of being highly viscous and/or more or less form-retaining. In a preferred embodiment the transport of water takes place by evaporation. In his case the bonded water is released from the gel body and carried into the local atmosphere, which results in an increase in the moisture content in the local atmosphere. In another preferred embodiment the transport of water takes place by absorption. Water present in the atmosphere is absorbed by the gel body, which results in a decrease in the moisture content in the local atmosphere. In a particular embodiment the gel body is adapted for full exchange of water with the local atmosphere. The moisture content is determined in this case by means of a combination of evaporation of water and absorption of water. Examples of components which can both absorb and relinquish moisture (hygroscopicity) are mono-propylene-glycol, referred to hereinbelow as glycol, and soda-like and glycerine-like components. Owing to the minimal displacement of the molecules in a gel body compared with a liquid, contamination of the gel body, for instance by bacterial growth, will be limited in the most unfavourable case to the outside of the gel body. A gel body has the very significant advantage for application in the method that it provides exchange of moisture with the environment Not only is an increase in the relative humidity therefore realized by means of a gel body, a reduction in the relative humidity is also possible by means of moisture absorption when a threshold value is exceeded. A further advantage of using a gel body is that use is made in very efficient manner of an available space; the space taken up by a gel body does after all consist almost entirely of material which can evaporate, which is very much preferable to the use of absorption cores which take up space, part of which is then not used effectively, and which generally have an environmental impact. In the case of complete evaporation only a very limited and harmless residue will remain behind which still has absorbent properties.

The American patent U.S. Pat. No. 4,934,524 describes a package for packaging articles such as cigarettes. The package comprises a moisture-control element and a receptacle for articles adjacently of the moisture-control element. The package is manufactured such that it has poor moisture permeability. The moisture control element can be filled with a liquid, a gel or other type of material. In accordance with the main claim of this American publication, there is no free space present inside the package between the moisture-control element and the receptacle for articles.

In preferred applications of the method the speed of exchange of moisture with the environment by the gel body and the point of transition of the body from absorption to evaporation is at least partly determined by the chemical composition, the physical composition and/or the moisture exchange surface area of the gel body. The properties of the gel body can include, among others: the limits of relative humidity for evaporation/absorption, the speed of evaporation and the speed of absorption. The local relative air humidity, for instance in a specific packaging and at a determined temperature can thus be determined by the properties of the gel body. The relative air humidity (in %) remains constant as temperatures change. The absolute moisture content (in mg/cm3) depends however on the temperature. In situations where the temperature changes, the system can also be adjusted such that the relative air humidity is modified such that the absolute air humidity remains constant. The chemical composition can for instance be varied by applying varying ratios of (mono-)propylene glycol, glycerine and water, optionally in combination with other substances influencing the speed of exchange and the point of transition from evaporation to absorption. It is also conceivable here to construct the gel body from two or more components built up of diverse substances and having varying (evaporation/absorption) properties in order to thus obtain an exchange characteristic of moisture with the environment which precisely matches a predetermined desired pattern. The physical properties can be understood to refer for instance to the viscosity of the gel body and gel structure (homogeneous gel against a crystalline gel, or a combination hereof). The exchange surface area can be determined by the form and dimensioning of a gel body. Apart from the chemical composition which here also plays an important part, it thus becomes possible to embody a gel body such that at a determined temperature a more or less stationary local relative humidity of a desired level is achieved. It is usual to maintain a relative humidity of about 70% at a temperature of 20° C. in a humidor for cigars, but with the method according to the invention it is also possible to maintain a relative humidity of for instance 60% or 80% in a humidor, subject to the specific wishes of the user and the cigars for conserving. According to the invention the relative humidity can also be controlled wholly independently of the temperature. The manner in which the moisture is bonded to a component determines the range of the moisture content. Any desired relative humidity can in principle be realized.

In yet another preferred application of the method the gel body is assembled close to the location of use thereof by adding water to a gel-forming material. In the most advantageous situation such a gel-forming material consists of a dry powder or granulate, but a liquid gel-forming material can also be applied for this purpose, for instance a mono-propylene and/or a glycerine. Transport and storage of the gel-forming material is thus much simpler than that of ready-to-use gel bodies. In addition, the shelf-life and the hygiene of this method is also better than that of ready-to-use gel bodies. Finally, the design and assembly of a gel body according to this method can also be adapted in simple manner to specific conditions of use. This variant of the method can also be performed simply if the gel-forming material is supplied in portions in a water-permeable packaging such that when the external package is brought into contact with water a gel body of the desired dimension forms. Such an external package with gel-forming material also forms part of the present application.

In yet another preferred application of the method at least one ambient condition (the temperature and/or humidity of the environment) is visualized by a colour indicator forming part of the gel body. An indication for instance of the temperature and/or the relative humidity in the environment of the gel body can be given by means of a colour indicator. In this way a signal can also be given for removal/replacement of a gel body (for instance because of ageing, bacterial contamination, less effective functioning etc.). The colour indicator can be mixed with the gel, although it is also possible to print on the gel body. Other additives can also be added to a gel body, such as for instance aromatic substances, taste-enhancing substances, preservatives and so on.

The invention also provides a gel body for applying the method according to the invention, wherein the gel body comprises an air humidifying substance into which water is bonded according claim 12. Such a gel body can as required be at least partially combined with an external structure manufactured form an absorption material (an external structure for holding the gel body) and/or be enclosed by an envelope permeable to the air-humidifying substance, which envelope can for instance also be biodegradable. By means of such a gel body the advantages can be realize as described above with reference to the method according to the invention. During evaporation other components also evaporate proportionally to the water, so that the physical properties of the gel remain constant despite evaporation which is occurring and without the danger of flow of for instance glycol occurring, such as is possible in the existing absorption gels. The invention thus provides a dry and stable system for air humidification. The placing, replacement and/or positioning of a gel body can be simplified by at least partly combining the gel body with an absorption material.

The invention further provides a device for controlling the moisture content of the atmosphere according claim 14. in and at least substantially closed space, comprising: a housing enclosing the space and at least one receptacle arranged in the space at least substantially closed by the housing for containing a gel forming material, wherein the receptacle for containing the gel forming material is adapted to accommodate a gel body. For optimal operation the housing is preferably at least substantially medium-tight and the housing is preferably provided with a closeable access. The space can consist of the already mentioned humidor, although all kinds of other spaces can also be envisaged such as for instance houses (hospitals), cars, glasshouses, storage spaces, exhibition areas, plant holders, cases for musical instruments, wine cabinets, packages for reeds for wind instruments and so on. Particularly favourable results are however anticipated if the device housing is a packaging for containing tobacco products, in particular a cigars housing. Such a package can be said humidor, but it is also possible for it to be an existing cigar package such as various types of box or (single) cigar case. It is however noted with emphasis that the method and the gel body according to the invention can also be used in a space which is not closed. The moisture content of objects placed in non-enclosed spaces, such as for instance furniture, works of art, musical instruments (pianos, grand pianos) and the like can thus also be conditioned by means of tie present invention. It is also conceivable to arrange a gel body according to the invention in or contiguously of a cork of a wine bottle so as to keep the moisture in the cork constant.

The present invention will be further elucidated with reference to the non-limitative embodiments shown in the following figures. Herein:

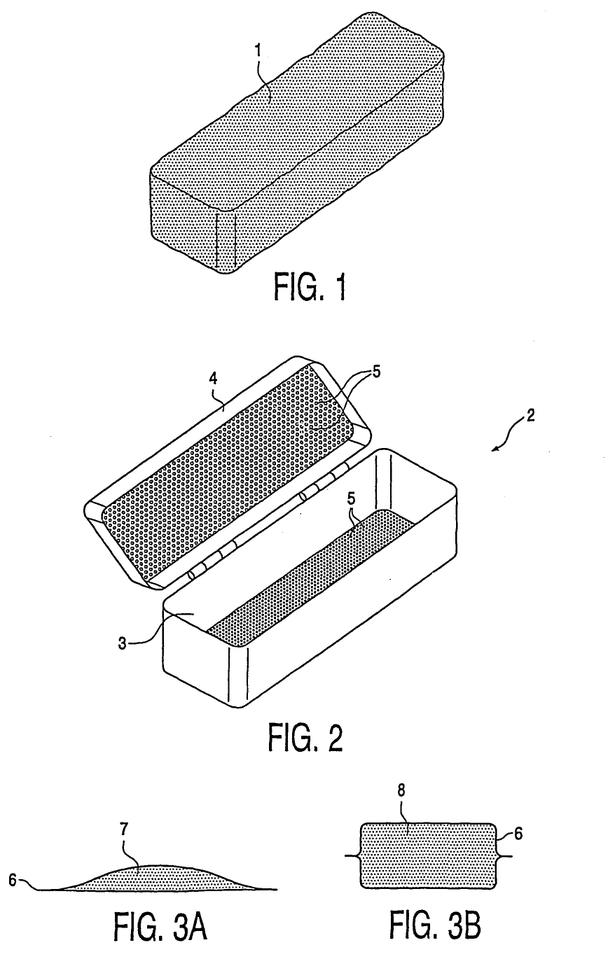

FIG. 1 shows a perspective view of a gel body according to the invention,

FIG. 2 shows a perspective view of an external package for a gel body according to the invention,

FIG. 3a shows a cross-section through a receptacle with gel-forming material prior to addition of water,

FIG. 3b shows a cross-section through the receptacle with gel-forming material of FIG. 3a after addition of water,

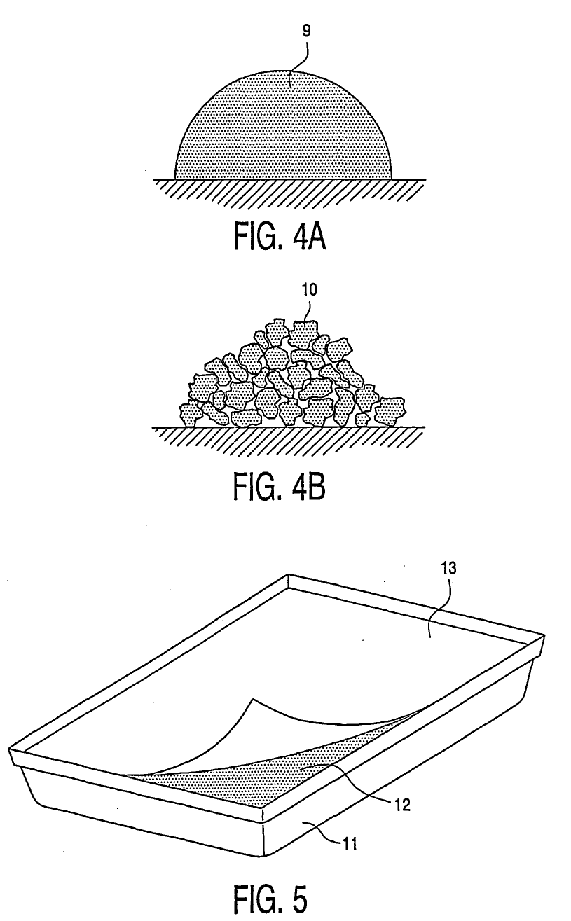

FIG. 4a is a schematic view of a homogeneous gel,

FIG. 4b is a schematic view of a crystalline gel, and

FIG. 5 is a perspective view of a receptacle with a gel body according to the invention arranged therein.

FIG. 1 shows a gel body 1 which can be placed in a space to which the gel body 1 is adapted. In order to protect gel body 1 from external loads, it can for instance be placed in an external package 2 as shown in FIG. 2. The external package 2 consists of a receiving space 3 for gel body 1 which can be covered with a lid 4. Arranged in receiving space 3 and lid 4 are openings 5 for passage of water vapour vaporated by gel body 1 or to be absorbed by the gel body. The external package 2 can for instance be placed in free-lying manner or be arranged magnetically coupled in a space for conditioning. An external package 2 in combination with a gel body 1 is also referred to as a closed system.

FIG. 3a shows a flexible external package 6 in which is situated a substance in powder form 7 consisting of a material fanning gel when water is added. The flexible external package 6 is permeable to water and water vapour and can be formed by a material such as for instance a specific type of textile or a non-woven material. After the addition of water a gel body 8 as shown in FIG. 3b forms in external package 6.

FIG. 4a shows schematically it homogeneous gel 9 (a homogeneous mass), while FIG. 4b shows schematically a crystalline gel 10 (loose fragments of gel). Practically no air is enclosed in homogeneous gel 9. Here the active evaporation surface area is limited compared to the crystalline gel 10. In crystalline gel 10 the evaporation surface area is larger than in homogeneous gel 9.

FIG. 5 finally shows a receptacle 11 in which a gel body 12 is accommodated. As the external package 2 as shown in FIG. 2, such a receptacle 11 with gel body 12 is als designated as a hygrolator or humidifier in the conserving of cigars. To perform the method according to the invention the receptacle 11 must be placed in a space for conditioning (not shown). In order to shield the gel body 1.2 from external loads and/or contaminants, the gel body 12 is shielded on the open side of receptacle 11 by a permeable filter material 13 which also functions as an exchange surface with the environment of a constant size. Filter material 13 can consist of an external absorption material. Such a receptacle 11 with gel body 12 is also referred to as an open system.

Although the present invention is elucidated with reference to only a few embodiments, it will be apparent to all that the invention is by no means limited to the described and shown embodiments. On the contrary, many variations are still possible for the skilled person within the scope of the invention. Instead of being used in a wholly independent application, he method and the gel body according to the invention can thus also be used in combination with an electronic control system.

1. Method for controlling the moisture content of a local atmosphere, wherein at least one gel body (1,8,12) is placed in the atmosphere for influencing, into which gel body is bonded water, wherein the moisture content is determined by means of transport of water between the gel body and the local atmosphere, characterized in that the point of transition of the gel body (1, 8, 12) from absorption to evaporation is at least partly influenced by varying the chemical composition of the gel body (1, 8, 12).

2. Method as claimed in claim 1, characterized in that the chemical composition of the gel body (1,8,12) is varied by applying varying ratio's of (mono)propylene, glycol, glycerine and water.

23. Method as claimed in claim 1, characterized in that the transport of water takes place by evaporation of water from the gel body (1,8,12).

34. Method as claimed in either of the foregoing claims, characterized in that

45. Method as claimed in any of the foregoing claims, wherein the speed of exchange of moisture with the environment by the gel body (1,8,12) and the point of transition of the cell body (1,8,12) from absorption to evaporation is at least partly determined by the chemical composition of the gel body (1,8,12).

65. Method as claimed in any of the foregoing claims, wherein the speed of exchange of moisture with the environment by the gel body (1,8,12) and the point of transition of the gel body (1,8,12) form absorption to evaporation is at least partly determined by the physical composition of the gel body (1,8,12).

76. Method as claimed in any of the foregoing claims, wherein the speed of exchange of moisture with the environment by the gel body (1,8,12) and the point of transition of the gel body (1,8,12) from absorption to evaporation is at least partly determined by the exchange surface area of the gel body (1,8,12).

87. Method as claimed in any of the foregoing claims, wherein the gel body (1,8,12) is assembled close to the location of use thereof by adding water to a gel-forming material (7).

98. Method as claimed in any of the foregoing claims, wherein the temperature and/or the humidity of the environment at least one ambient condition is visualized by a colour indicator forming part of the gel body (1,8,12).

109. Method as claimed in any of the foregoing claims, wherein during the evaporation of the moisture at least some of a component, not being water, forming part of the gel body (1,8,12) also evaporates.

110. Method as claimed in claim 9, wherein the quantity of evaporated moisture is proportional to the quantity of evaporated component.

121. Gel body (1,8,12) for applying the method as claimed in any of the foregoing claims, wherein the gel body (1,8,12) comprises an air-humidifying substance into which water is bonded, characterised in that the chemical composition of the gel body (1,8,12) influcences at least partly the point of transition of the gel body (1,8,12) from absorption to evaporation.

132. Gel body (1,8,12) as claimed in claim 121, wherein the gel body (1,8,12) is at least partly combined with an absorption material.

143. Device for controlling the moisture content of the atmosphere in a space, comprising:
a gel body as claimed in one of the claims 12 or 13,
a housing at least substantially enclosing the space, and
at least one receptacle (2,11) arranged in the space at least substantially closed by the housing for containing a material regulating the relative humidity, wherein the receptacle (2,11) for containing the material regulating the relative humidity is adapted to accommodate a gel body (1,8,12).

154. Device as claimed in claim 143, wherein the housing is at least substantially medium-tight.

165. Device as claimed in claim 143 or 154, wherein the housing is provided with a closable access.

176. Device as claimed in any of the claims 143-165, wherein the device is a packaging for containing tobacco products, in particular at least one a cigar housing.
